(19) United States
(12) Patent Application Publication
(10) Pub. No.: US 2026/0057589 A1
(43) Pub. Date: Feb. 26, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventors: Kazuya SADAKATA, Tokyo (JP); Taiga GOTO, Tokyo (JP)

(73) Assignee: FUJIFILM Corporation, Tokyo (JP)

(21) Appl. No.: 19/306,121

(22) Filed: Aug. 21, 2025

(30) Foreign Application Priority Data
Aug. 23, 2024 (JP) 2024-143373

(51) Int. Cl. G06T 11/00; G06T 5/50

(52) U.S. Cl. CPC G06T 11/008; G06T 5/50; G06T 11/005; G06T 11/006; G06T 2207/10081; G06T 2207/20224

(57) ABSTRACT

An image processing apparatus generates a first image by extracting a first region which is a first artifact generation source from a CT image, generates a second image by subtracting a value determined according to a specific part from the first image, generates a third image by performing forward projection and back projection on the second image, generates a fourth image which is a difference image between the second image and the third image, and generates a fifth image by correcting an artifact in the CT image using the fourth image.

### CROSS-REFERENCE TO RELATED APPLICATION

This application claims priority from Japanese Patent Application No. 2024-143373, filed on Aug. 23, 2024, the entire disclosure of which is incorporated herein by reference.

### BACKGROUND

### 1. Technical Field

The present disclosure relates to an image processing apparatus, an image processing method, and an image processing program.

### 2. Description of the Related Art

WO2016/158138A1 discloses a technology of generating correction data by removing an artifact component caused by a metal from projection data obtained by a computed tomography (CT) scanning.

### SUMMARY

In the technology disclosed in WO2016/158138A1, an artifact caused by a metal is a correction target in a CT image. However, since there are causes of artifacts other than metals, there is room for improvement from the viewpoint of correcting the artifacts of the CT image with high accuracy.

The present disclosure has been made in consideration of the above circumstances, and an object of the present disclosure is to provide an image processing apparatus, an image processing method, and an image processing program capable of correcting artifacts in CT images with high accuracy.

According to a first aspect, there is provided an image processing apparatus comprising at least one processor, in which the processor is configured to: acquire a CT image; generate a first image by extracting a first region which is a first artifact generation source from the CT image; generate a second image by subtracting a value determined according to a specific part from the first image; generate a third image by performing forward projection and back projection on the second image; generate a fourth image which is a difference image between the second image and the third image; and generate a fifth image by correcting an artifact in the CT image using the fourth image.

According to a second aspect, in the image processing apparatus according to the first aspect, the processor is configured to: generate a sixth image by extracting a second region from the CT image, the second region being a second artifact generation source different from the first artifact generation source; generate a seventh image by subtracting a value determined according to the specific part from the sixth image; generate an eighth image by performing forward projection and back projection on the seventh image; generate a ninth image which is a difference image between the seventh image and the eighth image; and generate the fifth image using the fourth image and the ninth image.

According to a third aspect, in the image processing apparatus according to the first or second aspect, the specific part is a part whose CT value corresponds to water or calcium.

According to a fourth aspect, in the image processing apparatus according to any one of the first to third aspects, the CT image is an image captured by a CT apparatus including a photon counting type radiation detector.

According to a fifth aspect, in the image processing apparatus according to any one of the first to fourth aspects, the processor is configured to generate the second image by subtracting a value determined according to the specific part and a type of the CT image from the first image.

According to a sixth aspect, in the image processing apparatus according to the second aspect, the processor is configured to generate the seventh image by subtracting a value determined according to the specific part and a type of the CT image from the sixth image.

According to a seventh aspect, in the image processing apparatus according to any one of the first to sixth aspects, the first region is a region whose difference from a CT value corresponding to the specific part is equal to or greater than a predetermined value.

According to an eighth aspect, in the image processing apparatus according to the second aspect, the second region is a region whose difference from a CT value corresponding to the specific part is equal to or greater than a predetermined value.

According to a ninth aspect, in the image processing apparatus according to any one of the first to eighth aspects, the processor is configured to generate the first image by performing first threshold value processing on the CT image.

According to a tenth aspect, in the image processing apparatus according to the second aspect, the processor is configured to generate the sixth image by performing second threshold value processing on the CT image.

According to an eleventh aspect, there is provided an image processing method executed by a processor of an image processing apparatus including at least one processor, the image processing method comprising: acquiring a CT image; generating a first image by extracting a first region which is a first artifact generation source from the CT image; generating a second image by subtracting a value determined according to a specific part from the first image; generating a third image by performing forward projection and back projection on the second image; generating a fourth image which is a difference image between the second image and the third image; and generating a fifth image by correcting an artifact in the CT image using the fourth image.

According to a twelfth aspect, there is provided an image processing program for causing a processor of an image processing apparatus including at least one processor to execute: acquiring a CT image; generating a first image by extracting a first region which is a first artifact generation source from the CT image; generating a second image by subtracting a value determined according to a specific part from the first image; generating a third image by performing forward projection and back projection on the second image; generating a fourth image which is a difference image between the second image and the third image; and generating a fifth image by correcting an artifact in the CT image using the fourth image.

According to the aspects of the present disclosure, artifacts in CT images can be corrected with high accuracy.

### BRIEF DESCRIPTION OF THE DRAWINGS

FIG. 1 is a schematic diagram showing an example of a configuration of a tomographic imaging system.

FIG. 2 is a block diagram showing an example of a hardware configuration of a console.

FIG. 3 is a block diagram showing an example of a functional configuration of the console.

FIG. 4 is a diagram showing an example of each image generated by the console.

FIG. 5 is a flowchart showing an example of a tomographic image generating process.

FIG. 6 is a diagram showing an example of each image generated by a console according to a modification example.

### DETAILED DESCRIPTION

Hereinafter, form examples for implementing a technology of the present disclosure will be described in detail with reference to the drawings.

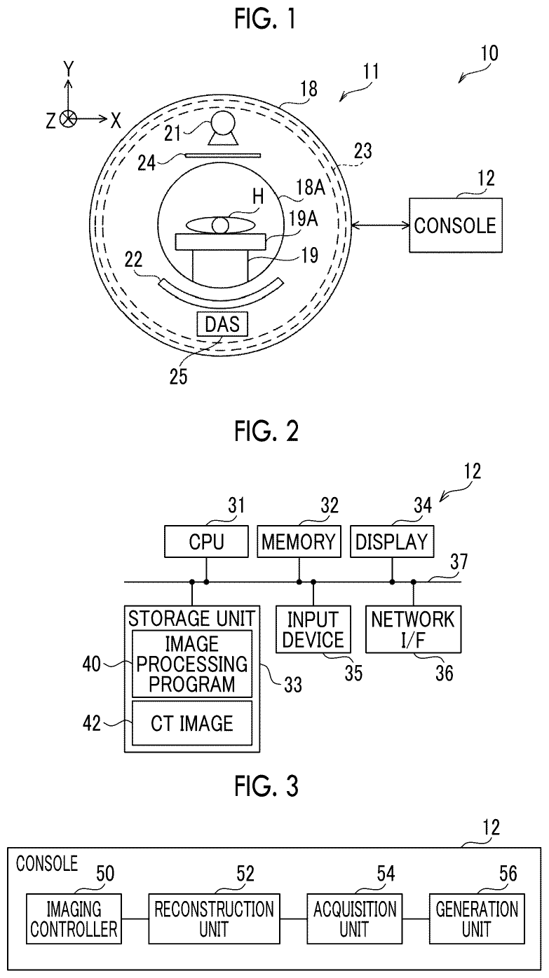

First, a configuration of a tomographic imaging system 10 will be described with reference to FIG. 1. As shown in FIG. 1, the tomographic imaging system 10 according to the present embodiment comprises a CT apparatus 11 and a console 12. The console 12 is an example of an image processing apparatus according to the disclosed technology.

The CT apparatus 11 obtains a tomographic image of a subject H by imaging the subject H using X-rays, which are an example of radiation. The CT apparatus 11 comprises a gantry 18 and a bed device 19. FIG. 1 is a diagram in which the gantry 18 and the bed device 19 are viewed from the front. The bed device 19 comprises a top plate 19A on which a subject H can be placed in a decubitus posture. In the following description, a longitudinal direction of the top plate 19A is defined as a Z-axis direction, a lateral direction of the top plate 19A is defined as an X-axis direction, and a vertical direction is defined as a Y-axis direction. The top plate 19A is movable in the Z-axis direction in a state of being kept horizontal. The gantry 18 has an annular shape as a whole, and a circular opening portion 18A having a diameter larger than a width of the top plate 19A is formed in the center. In a case of imaging, the top plate 19A on which the subject H is placed is moved in the Z-axis direction with respect to the gantry 18 to enter the opening portion 18A. Imaging is performed while the top plate 19A is moved with respect to the gantry 18.

A radiation source 21, a radiation detector 22, and a frame 23 are disposed inside the gantry 18. The radiation source 21 emits radiation toward the subject H. The radiation detector 22 detects the radiation that has transmitted through the subject H. The radiation that has transmitted through the subject H is attenuated by interaction (for example, absorption and scattering of radiation) with structures such as organs and bones within the body of the subject H. Each structure has its own unique attenuation coefficient for radiation, and the radiation that has transmitted through a structure carries information that reflects the physical properties of the structure. The radiation detector 22 detects radiation that reflects the physical properties of structures inside the body of the subject H. The radiation detector 22 has a detection surface on which detection elements are two-dimensionally arranged, and outputs a detection signal for each detection element. Therefore, the radiation detector 22 can detect radiation transmitting through the structure of the subject H at each transmission position. In addition, the radiation detector 22 has a substantially arcuate shape in accordance with the curvature of the gantry 18, and the detection surface is also curved.

Within the gantry 18, the radiation source 21 and the radiation detector 22 are disposed at positions facing each other, and rotate around the Z axis while maintaining an opposing posture. The frame 23 has an annular shape and supports the radiation source 21 and the radiation detector 22 to be freely rotatable. During imaging, the gantry 18 rotates the radiation source 21 and the radiation detector 22 around the subject H on the top plate 19A, and acquires detection signals from the radiation detector 22 at a plurality of circumferential positions around the Z axis, which corresponds to the body axis of the subject H. During imaging, the top plate 19A also moves in the Z-axis direction in synchronization with the rotation of the radiation source 21 and the radiation detector 22.

A data acquisition system (DAS) 25 collects the detection signals output by the radiation detector 22, generates projection data for each position around the Z axis based on the collected detection signals, and outputs the generated projection data to the console 12. Accordingly, the console 12 acquires radiation projection data for each position around the body axis of the subject H.

An irradiation field limiter 24 (also referred to as a collimator) that limits the irradiation field of radiation is disposed in front of the radiation source 21 in the irradiation direction. The irradiation field limiter 24 has an irradiation opening of which a contour is defined by a plurality of shielding plates that shield the radiation, and a size of the irradiation opening can be changed by moving the shielding plates. The radiation source 21 is supplied with a voltage from a high-voltage generator. The radiation source 21 and the radiation detector 22 are, for example, electrically connected to the frame 23 by a slip ring type, and power supply and data transmission and reception are performed via the slip ring. The slip ring type connection makes it possible to perform helical scan imaging, in which imaging is performed while rotating the radiation source 21 and the radiation detector 22 in one direction without reversing the rotation direction.

The console 12 controls the radiation source 21 and the radiation detector 22 via a control device (not shown) provided in the gantry 18. The imaging conditions of the CT apparatus 11 are set by operating the console 12. The imaging conditions include the body part of the imaging target, the radiation irradiation conditions of the radiation source 21, the imaging range, and the like. The irradiation condition of the radiation includes a tube voltage (unit: kv) applied to the radiation source 21, a tube current (unit: mA), and an irradiation time (unit: msec) of the radiation. The imaging range is adjusted, for example, in the X-Z plane by changing the size of the irradiation opening of the irradiation field limiter 24, and in the Z-axis direction by changing the movement range of the top plate 19A.

A hardware configuration of the console 12 according to the present embodiment will be described with reference to FIG. 2. Examples of the console 12 include a computer, such as a personal computer or a server computer. As shown in FIG. 2, the console 12 includes a central processing unit (CPU) 31, a memory 32 as a temporary storage area, and a non-volatile storage unit 33. In addition, the console 12 includes a display 34 such as a liquid-crystal display, an input device 35 such as a keyboard and a mouse, and a network interface (I/F) 36 connected to the CT apparatus 11. The CPU 31, the memory 32, the storage unit 33, the display 34, the input device 35, and the network I/F 36 are connected to a bus 37. The CPU 31 is an example of a processor.

The storage unit 33 is implemented using a hard disk drive (HDD), a solid-state drive (SSD), a flash memory, or the like. An image processing program 40 is stored in the storage unit 33 as a storage medium. The CPU 31 reads out the image processing program 40 from the storage unit 33, loads the image processing program 40 in the memory 32, and executes the loaded image processing program 40.

Further, the storage unit 33 stores a CT image 42. The CT image 42 includes a plurality of tomographic images generated by image reconstruction based on the projection data obtained by the CT apparatus 11.

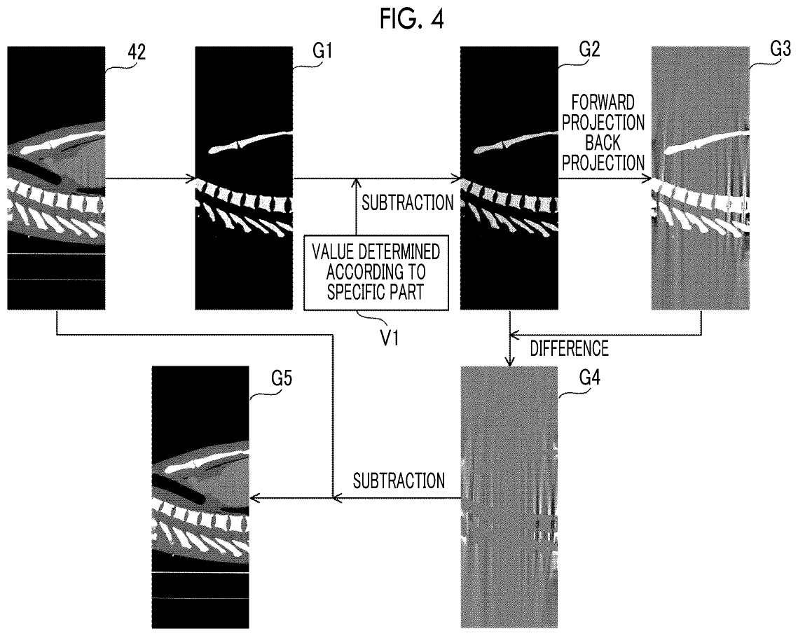

Next, the functional configuration of the console 12 will be described with reference to FIGS. 3 and 4. FIG. 3 shows an example of a functional block diagram of the console 12, and FIG. 4 shows an example of an image generated by the functional units of the console 12. As shown in FIG. 3, the console 12 includes an imaging controller 50, a reconstruction unit 52, an acquisition unit 54, and a generation unit 56. By executing the image processing program 40, the CPU 31 functions as the imaging controller 50, the reconstruction unit 52, the acquisition unit 54, and the generation unit 56.

The imaging controller 50 performs helical scan imaging by controlling the movement of the top plate 19A, the radiation source 21, and the radiation detector 22 in accordance with imaging conditions.

The reconstruction unit 52 reconstructs an image based on the projection data output from the DAS 25 under the control of the imaging controller 50, thereby generating a tomographic image. An image is reconstructed based on the projection data by, for example, a filtered back projection method. Then, the reconstruction unit 52 stores the CT image 42 including the plurality of generated tomographic images in the storage unit 33.

The acquisition unit 54 acquires the CT image 42 from the storage unit 33. As shown in FIG. 4, the generation unit 56 generates a first image G1 by extracting a first region, which is a first artifact generation source, from the CT image 42. In the present embodiment, the generation unit 56 generates a first image G1 by performing first threshold value processing on the CT image 42. In the present embodiment, a case in which the first region is a bone region will be described as an example.

Specifically, the generation unit 56 generates the first image G1 by comparing the CT value of each pixel in the CT image 42 with a threshold value set as a value for extracting bone regions, and performing image processing to binarize the CT image 42.

The generation unit 56 generates a second image G2 by subtracting a value V1 determined according to a specific part from the first image G1. The specific part referred to here means a part having a constant CT value. The specific part is, for example, a part whose CT value corresponds to water. In a CT image, a water part has a constant CT value of 0. The specific part may be a part whose CT value corresponds to calcium.

The specific part is set according to the imaging conditions. For example, in a case in which the imaging target included in the imaging conditions is the abdomen, a water part is predominant in the abdomen. In this case, the generation unit 56 generates a second image G2 by subtracting a value corresponding to water as the value V1 from each pixel of the first image G1.

The generation unit 56 generates a third image G3 by performing forward projection and back projection on the second image G2. The generation unit 56 generates a fourth image G4 which is a difference image between the second image G2 and the third image G3.

The generation unit 56 generates a fifth image G5 by correcting the artifact of the CT image 42 using the fourth image G4. Specifically, the generation unit 56 generates a fifth image G5 by subtracting the fourth image G4 from the CT image 42.

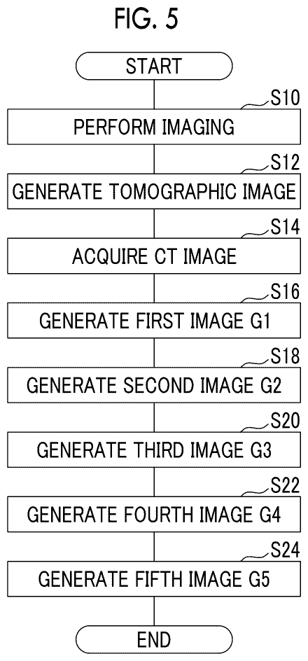

Next, the operation of the console 12 will be described with reference to FIG. 5. The CPU 31 executes the image processing program 40, whereby the tomographic image generating process shown in FIG. 5 is executed.

In Step S10 of FIG. 5, the imaging controller 50 performs helical scan imaging by controlling the movement of the top plate 19A, the radiation source 21, and the radiation detector 22 in accordance with imaging conditions. In Step S12, the reconstruction unit 52 reconstructs an image based on the projection data output from the DAS 25 under the control of Step S10, thereby generating a tomographic image. Then, the reconstruction unit 52 stores the CT image 42 including the plurality of generated tomographic images in the storage unit 33.

In Step S14, the acquisition unit 54 acquires the CT image 42 from the storage unit 33. In Step S16, the generation unit 56 generates a first image G1 by extracting a first region, which is a first artifact generation source, from the CT image 42 acquired in Step S14. In Step S18, the generation unit 56 generates a second image G2 by subtracting a value V1 determined according to a specific part from the first image G1 generated in Step S16.

In Step S20, the generation unit 56 generates a third image G3 by performing forward projection and back projection on the second image G2 generated in Step S18. In Step S22, the generation unit 56 generates a fourth image G4 which is a difference image between the second image G2 generated in Step S18 and the third image G3 generated in Step S20. In Step S24, the generation unit 56 generates a fifth image G5 by correcting the artifact of the CT image 42 using the fourth image G4 generated in Step S22. In a case in which the process of Step S24 ends, the tomographic image generating process ends.

As described above, according to the present embodiment, artifacts in CT images can be corrected with high accuracy. Furthermore, according to the present embodiment, a fixed value that is determined according to a specific part is used as the value to be subtracted from the first image G1. Therefore, the calculation cost can be reduced compared to the case in which a value that requires calculation using the CT values of regions in the CT image where the CT values vary, such as the average value of the CT values of soft tissue, is applied as the value to be subtracted from the first image G1.

In the above embodiment, a case has been described in which a bone region is applied as the first region which is the first artifact generation source, but the disclosed technology is not limited to this aspect. For example, as the first region, a region whose difference from a CT value corresponding to a specific part is equal to or greater than a predetermined value may be applied. Examples of this region include a region of a contrast medium.

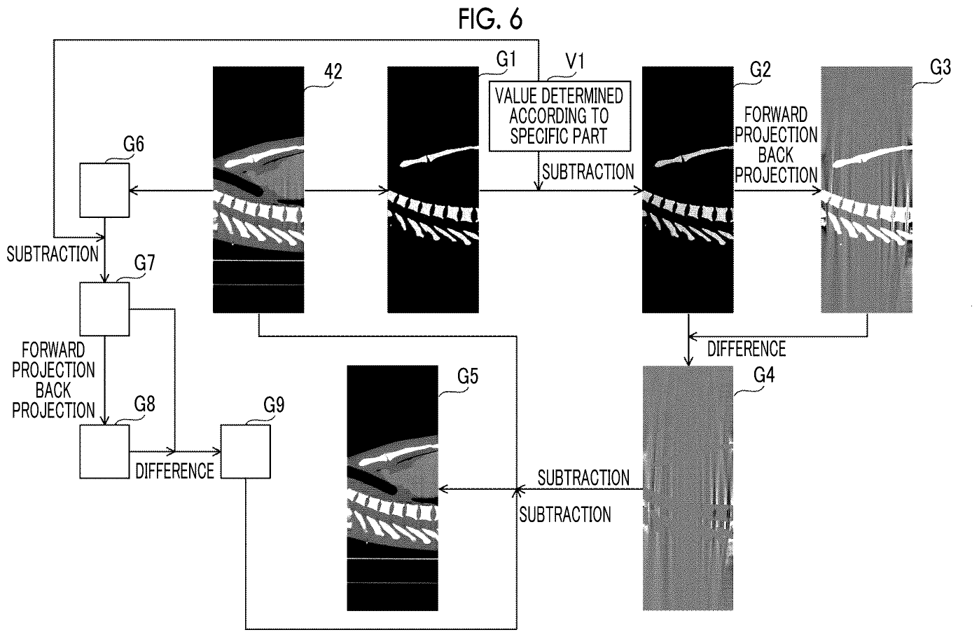

In addition, in the above embodiment, as shown in FIG. 6, the generation unit 56 may generate a sixth image G6 by extracting a second region, which is a second artifact generation source different from the first artifact generation source, from the CT image 42. In this case, the generation unit 56 may generate the sixth image G6 by performing second threshold value processing on the CT image 42. Examples of the second region include an air region. Specifically, the generation unit 56 may generate the sixth image G6 by comparing the CT value of each pixel in the CT image 42 with a threshold value set as a value for extracting air regions, and performing image processing to binarize the CT image 42. As the second region, a region whose difference from a CT value corresponding to a specific part is equal to or greater than a predetermined value may be applied. Examples of this region include a region of a contrast medium.

In this form example, the generation unit 56 may generate a seventh image G7 by subtracting a value V1 determined according to a specific part from the sixth image G6. In addition, the generation unit 56 may generate an eighth image G8 by performing forward projection and back projection on the seventh image G7. Furthermore, the generation unit 56 may generate a ninth image G9 which is a difference image between the seventh image G7 and the eighth image G8. The generation unit 56 may also generate the fifth image G5 using the fourth image G4 and the ninth image G9. In this case, the generation unit 56 may generate a fifth image G5 by subtracting the fourth image G4 and the ninth image G9 from the CT image 42.

Also, a case has been described in which an air region is applied as the second region which is the second artifact generation source, but the disclosed technology is not limited to this aspect. For example, as the second region, a region whose difference from a CT value corresponding to a specific part is equal to or greater than a predetermined value may be applied. Examples of this region include a region of a contrast medium.

In the above embodiment, the radiation detector 22 may be a photon counting type radiation detector. In other words, the CT image 42 may be an image captured by a CT apparatus including a photon counting type radiation detector.

In the above embodiment, the generation unit 56 may generate the second image G2 by subtracting a value determined according to a specific part and a type of the CT image 42 from the first image G1. In this form example, a value to be subtracted from the first image G1 may be associated with a combination of a specific part and a type of the CT image 42. Examples of a type of the CT image 42 include a material discrimination image, a virtual monochromatic image, and an electron density image. This type of CT image is captured by a CT apparatus including a photon counting type radiation detector. In addition, this type of CT image is captured by a dual energy CT apparatus.

Similarly, the generation unit 56 may generate the seventh image G7 by subtracting a value determined according to a specific part and a type of the CT image 42 from the sixth image G6.

In addition, in the above embodiment, the generation unit 56 may generate the first image G1 by extracting a first region, which is the first artifact generation source, from the CT image 42 by inputting the CT image 42 into a trained model obtained by machine learning such as deep learning. Similarly, the generation unit 56 may generate the sixth image G6 by extracting a second region, which is the second artifact generation source, from the CT image 42 by inputting the CT image 42 into a trained model obtained by machine learning such as deep learning.

In the above embodiment, the generation unit 56 may use the generated fifth image G5 as a new CT image 42 and repeatedly execute the processes of Steps S16 to S24.

Furthermore, at least one of the functional units provided in the console 12 in the above embodiment may be provided in another device, such as a control device provided in the gantry 18.

In addition, in the above-described embodiment, for example, various processors shown below can be used as a hardware structure of a processing unit that executes various types of processing, such as each functional unit of the console 12. The various processors include, in addition to a CPU that is a general-purpose processor functioning as various processing units by executing software (program) as described above, a programmable logic device (PLD) that is a processor whose circuit configuration can be changed after manufacture such as an FPGA, a dedicated electrical circuit that is a processor having a circuit configuration dedicatedly designed to execute specific processing such as an application-specific integrated circuit (ASIC), and the like.

One processing unit may be configured by one of the various processors, or may be configured by a combination of the same or different kinds of two or more processors (for example, a combination of a plurality of FPGAs or a combination of the CPU and the FPGA). Alternatively, a plurality of processing units may be configured by one processor.

As an example in which a plurality of processing units are configured by one processor, first, there is a form in which one processor is configured by a combination of one or more CPUs and software as typified by a computer, such as a client or a server, and this processor functions as a plurality of processing units. Second, there is a form in which a processor for realizing the function of the entire system including a plurality of processing units via one integrated circuit (IC) chip as typified by a system-on-chip (SoC) or the like is used. In this way, various processing units are configured by one or more of the above-described various processors as hardware structures.

Further, as the hardware structure of the various processors, more specifically, an electrical circuit (circuitry) in which circuit elements such as semiconductor elements are combined can be used.

In the above embodiment, the image processing program 40 is described as being stored (installed) in the storage unit 33 in advance; however, the present disclosure is not limited thereto. The image processing program 40 may be provided in a form recorded in a recording medium such as a compact disc read-only memory (CD-ROM), a digital versatile disc read-only memory (DVD-ROM), and a universal serial bus (USB) memory. In addition, the image processing program 40 may be configured to be downloaded from an external device via a network. The image processing program 40 can be provided as a program product. The program product includes products in all aspects for providing a program. For example, the program product includes a program provided through a network such as the Internet, and a non-transitory computer readable recording medium such as a CD-ROM or a DVD in which the program is stored.

What is claimed is:

1. An image processing apparatus comprising at least one processor,
wherein the processor is configured to:
acquire a CT image;
generate a first image by extracting a first region which is a first artifact generation source from the CT image;
generate a second image by subtracting a value determined according to a specific part from the first image;
generate a third image by performing forward projection and back projection on the second image;
generate a fourth image which is a difference image between the second image and the third image; and
generate a fifth image by correcting an artifact in the CT image using the fourth image.

2. The image processing apparatus according to claim 1,
wherein the processor is configured to:
generate a sixth image by extracting a second region from the CT image, the second region being a second artifact generation source different from the first artifact generation source;
generate a seventh image by subtracting a value determined according to the specific part from the sixth image;
generate an eighth image by performing forward projection and back projection on the seventh image;
generate a ninth image which is a difference image between the seventh image and the eighth image; and
generate the fifth image using the fourth image and the ninth image.

3. The image processing apparatus according to claim 1,
wherein the specific part is a part whose CT value corresponds to water or calcium.

4. The image processing apparatus according to claim 1,
wherein the CT image is an image captured by a CT apparatus including a photon counting type radiation detector.

5. The image processing apparatus according to claim 1,
wherein the processor is configured to generate the second image by subtracting a value determined according to the specific part and a type of the CT image from the first image.

6. The image processing apparatus according to claim 2,
wherein the processor is configured to generate the seventh image by subtracting a value determined according to the specific part and a type of the CT image from the sixth image.

7. The image processing apparatus according to claim 1,
wherein the first region is a region whose difference from a CT value corresponding to the specific part is equal to or greater than a predetermined value.

8. The image processing apparatus according to claim 2,
wherein the second region is a region whose difference from a CT value corresponding to the specific part is equal to or greater than a predetermined value.

9. The image processing apparatus according to claim 1,
wherein the processor is configured to generate the first image by performing first threshold value processing on the CT image.

10. The image processing apparatus according to claim 2,
wherein the processor is configured to generate the sixth image by performing second threshold value processing on the CT image.

11. An image processing method executed by a processor of an image processing apparatus including at least one processor, the image processing method comprising:
acquiring a CT image;
generating a first image by extracting a first region which is a first artifact generation source from the CT image;
generating a second image by subtracting a value determined according to a specific part from the first image;
generating a third image by performing forward projection and back projection on the second image;
generating a fourth image which is a difference image between the second image and the third image; and
generating a fifth image by correcting an artifact in the CT image using the fourth image.

12. A non-transitory computer-readable storage medium storing an image processing program for causing a processor of an image processing apparatus including at least one processor to execute:
acquiring a CT image;
generating a first image by extracting a first region which is a first artifact generation source from the CT image;
generating a second image by subtracting a value determined according to a specific part from the first image;
generating a third image by performing forward projection and back projection on the second image;
generating a fourth image which is a difference image between the second image and the third image; and
generating a fifth image by correcting an artifact in the CT image using the fourth image.
